(19) United States
(12) Patent Application Publication
(10) Pub. No.: US 2010/0048202 A1
(43) Pub. Date: Feb. 25, 2010

(54) METHOD OF COMMUNICATING WITH AN AVIONICS BOX VIA TEXT MESSAGING

(76) Inventors: William H. Beacham, Jr., Enfield, CT (US); David M. Mattei, Bolton, CT (US); Paul Raymond Scheid, West Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/197,354

(22) Filed: Aug. 25, 2008

(51) Int. Cl. G06F 17/00; H04W 4/00

(52) U.S. Cl. 455/431; 701/2; 455/466

(57) ABSTRACT

An example method of communicating with an aircraft includes receiving a text message with an aircraft avionics box and initiating an operation with the aircraft avionics box based on the text message.

### BACKGROUND

This application relates to communicating with an avionics box using a text message.

Aircraft typically include multiple avionics boxes. As known, avionics boxes are mounted with the aircraft and collect information related to the aircraft, such as environmental conditions, flight times, etc. Many avionics boxes are configured to perform other aircraft system operations such as controlling portions of the aircraft. As an example, some avionics boxes include programs that, when executed, initiate a procedure that monitors a portion of the aircraft during operation. The avionics boxes store the results of the procedure within electronic data files for later review and analysis. Many avionics boxes organize the electronic data files within a file directory. Electronic data files and other types of information are typically downloaded through a wired connection or the recording media is physically removed from the avionics boxes after the aircraft lands.

During operation, an operator onboard the aircraft may interact with the avionics box to monitor data collections or initiate procedures. An operator on the ground can similarly interact with the avionics boxes, but must typically rely on very high frequency radio-based communications to carry out the desired interactions. Systems on the ground capable of these very high frequency communications are often fixed in a particular location, complicated, and costly. Some aircraft utilize Aircraft Communication and Reporting Systems to communicate visual messages to aircraft personnel. As known, these systems are slow, expensive, and require specialized equipment to operate.

### SUMMARY

An exemplary method of communicating with an aircraft includes receiving a text message with an aircraft avionics box and initiating an operation with the aircraft avionics box based on the text message.

An exemplary avionics box for an aircraft includes an avionics box operative to receive a text message and to initiate an aircraft system operation based on the text message.

An exemplary aircraft communication system includes an avionics box mountable within an aircraft, the avionics box includes a cellular modem function. A portable unit is operative to communicate with the cellular modem function. The portable unit and the cellular modem function are operative to communicate using a text message.

These and other features of the example disclosure can be best understood from the following specification and drawings, the following of which is a brief description:

### BRIEF DESCRIPTION OF THE DRAWINGS

FIG. 1 shows a schematic view of an example avionics box.

FIG. 2 shows a partial schematic view of an example arrangement for controlling an avionics box.

### DETAILED DESCRIPTION

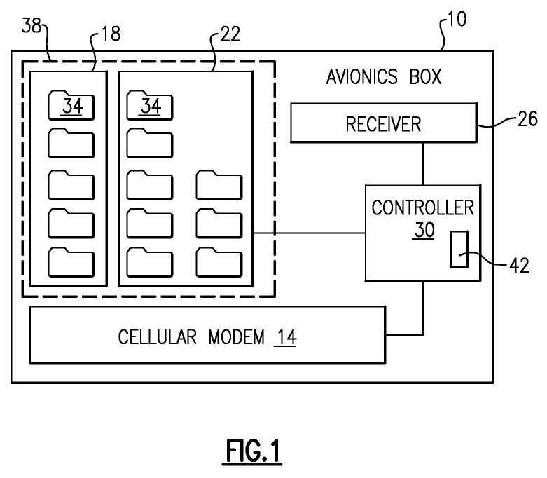

Referring to FIG. 1, an example avionics box 10 includes a cellular modem function 14, a removable memory 18, a fixed memory 22, a receiver 26, and a controller 30. The cellular modem function 14 is operative to send and receive cellular communications. The removable memory 18 and the fixed memory 22 each include a plurality of data files 34, which are arranged in a file directory 38. The receiver 26 is configured to receive wireless communications, such as very high frequency radio communications. The controller 30 includes software in the form of a computing device portion 42. The controller 30 is in communication with the file directory 38, the receiver 26, and the cellular modem portion 14.

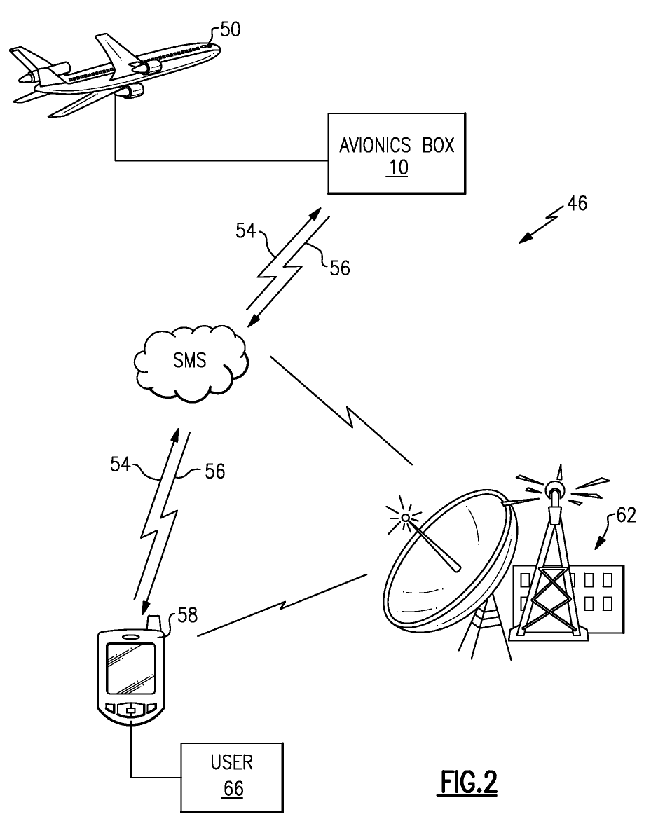

Referring now to FIG. 2 with continuing reference to FIG. 1, the example avionics box 10 forms a portion of an aircraft communication system 46 and is operative to receive a text message 54 from a cellular telephone 58, a communication station 62, or both. The example communication station 62 also communicates with the avionics box 10 with very high frequency radio communications.

In other examples, different types of portable devices or cellular devices are used in place of the cellular telephone 58.

In this example, the text message 54 adheres to a short message service (SMS) type cellular communication protocol and is thus an SMS message. As known, SMS type communications are a standard communication protocol available in cellular modems and other cellular devices.

The example avionics box 10 receives the text message 54 while the aircraft 50 is on the ground. A user 66 uses the cellular telephone 58 to enter the text message 54, which is then communicated directly to the aircraft 50. In other examples, the avionics box 10 receives the text message 54 when the aircraft 50 is in the air. In still other examples, the text message 54 is communicated first to the communication station 62, which then communicates the text message 54 to the avionics box 10.

The example text message 54 initiates an operation performed by the avionics box 10, requests information about the aircraft 50, or initiates other types of aircraft system operations. In one example, the text message 54 requests that the avionics box 10 provide the amount of available removable memory 18. Although the user 66 creates the text message 54 in this example, other examples include the user 66 selecting the text message 54 from a listing of messages programmed into the cellular telephone 58.

In response to the text message 54 from the cellular telephone 58, the controller 30 calculates the amount of available removable memory 18 and initiates another text message 56 that is communicated back to the cellular telephone 58. The user 66 is then able to review the text message 56, which contains the amount, on the cellular telephone 58.

The text message 54 from the user 66 initiates several types of operations related to the aircraft 50. Other example aircraft system operations carried out by the avionics box 10 in response to the text message 54 include deleting one or more of the data files 34, executing a program stored within one of the data files 34, restructuring the file directory 38, measuring a condition sensed by a sensor, etc.

In another example, the avionics box 10 automatically sends the text message 56 to the cellular telephone 58. That is, the avionics box 10 sends the text message 56 to the cellular telephone 58 without a prompting by the user 66 or receipt of the text message 54 containing a request. In such an example, the avionics box 10 sends the text message 56 based on a passage of time, crossing a particular threshold of available memory, etc.

It should be noted that a computing device portion 42 or software portion of the controller 30 within the avionics box 10 can be used to implement various functionality, such as that attributable to the hybrid fault reasoning system. In terms of hardware architecture, the example computing device portion 42 can include a processor, additional memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)), nonvolatile memory elements (e.g., ROM, hard drive, tape, CD-ROM, etc.), or reprogrammable devices (FLASH, EEPROM, NOVRAM). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, generic relay drivers, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

Although a preferred embodiment has been disclosed, a worker of ordinary skill in this art would recognize that certain modifications would come within the scope of this invention. For that reason, the following claims should be studied to determine the true scope and content of this invention.

We claim:

1. A method of communicating with an aircraft, comprising:
receiving a text message with an aircraft avionics box; and
initiating an operation with the aircraft avionics box based on the text message.

2. The method of claim 1, wherein the text message is a short message service communication.

3. The method of claim 1, wherein the aircraft avionics box includes a cellular modem operative to receive the text message.

4. The method of claim 3, wherein the cellular modem is operative to send a second text message.

5. The method of claim 1, wherein the aircraft avionics box receives the text message from a cellular device.

6. The method of claim 1, wherein the text message is selected from a list of multiple text messages stored on a cellular device.

7. An avionics box for an aircraft, comprising:
an avionics box operative to receive a text message and to initiate an aircraft system operation based on the text message.

8. The avionics box of claim 7, wherein the text message is a short message service communication.

9. The avionics box of claim 7, wherein the text message is a cellular short message service communication.

10. The avionics box of claim 7, including a cellular modem operative to receive text message.

11. The avionics box of claim 7, wherein the avionics box is operative to send a text message.

12. The avionics box of claim 7, wherein the avionics box is operative to receive the text message from a cellular telephone.

13. An aircraft communication system, comprising:
an avionics box mountable within an aircraft;
a cellular modem function of the avionics box; and
a portable unit operative to communicate with the cellular modem function, wherein the portable unit and the cellular modem portion communicate using a text message.

14. The aircraft communication system of claim 13, wherein the text message is a short message service communication.

15. The aircraft communication system of claim 13, wherein the avionics box is operative to receive very high frequency communications.

16. The aircraft communication system of claim 13, wherein the portable unit is a cellular telephone.
